(19) United States
(12) Patent Application Publication
(10) Pub. No.: US 2006/0039632 A1
(43) Pub. Date: Feb. 23, 2006

(54) Dynamic pressure bearing assembly

(76) Inventor: Shu-Chin Huang, Taoyuan (TW)

Correspondence Address: BACON & THOMAS, PLLC, 625 SLATERS LANE, FOURTH FLOOR, ALEXANDRIA, VA, 22314, US

(21) Appl. No.: 10/921,968

(22) Filed: Aug. 20, 2004

(51) Int. Cl. F16C 32/06

(52) U.S. Cl. 384/100

(57) ABSTRACT

The present invention discloses an improved dynamic pressure bearing assembly, comprising a bearing, an axial hole passing through the bearing, a plurality of aslant planes milled by a milling machine and extended along the axial direction and disposed on the periphery of the axial hole, and a dynamic pressure generating groove disposed among the planes. The dynamic pressure generating groove comprises a fluid lubricating medium therein, and thus the periphery of the axial hole can be manufactured on the planes very easily, and thus not only making the manufacturing easier, but also providing the required precision. Further, the present invention can evenly eject the fluid contained in everywhere inside each dynamic pressure generating groove towards the axle center by the drag of the centrifugal force, and further fix the axle center in place and maintain the axle center at the central position in the bearing.

### BACKGROUND OF THE INVENTION

1. Field of the Invention

The present invention relates to an improved dynamic pressure bearing assembly, more particularly to a bearing assembly comprising a plurality of inclined planes extended along the axial directions and disposed on the inner wall of the bearing, and such planes define a dynamic pressure generating groove, and the bearing assembly features an easy manufacturing.

2. Description of the Related Art

A bearing is a device generally being applied to a rotary mechanics and used for the supporting, reducing friction and bearing loads; for example, a bearing is used in an axle motor. As the science and technology advance, the components are getting smaller and more precise, and thus the demand for the precision of a bearing is getting higher and higher. In general, a ball bearing is the common one that demands a high precision. However, there exist some problems including the noise, the insufficient precision of the rotation, the high cost for miniaturization and the incompliance with the requirements for miniaturization and precision.

To meet with the foregoing requirements and further to reduce the rotary friction, fluid bearings are presented to the public. The fluid bearing not only has high precision, but also features low noise and excellent shock resistance. The fluid bearing is generally divided into two types: static pressure fluid bearing and dynamic pressure fluid bearing. The static pressure fluid bearing has the fluid lubricating medium inside the bearing under normal conditions, and the pressure of the fluid supports the axle center when the bearing rotates. If the axle center shifts, then the shifted side is pressurized as to resume the correct position of the axle center. Since the static pressure bearing always has a large quantity of fluid lubricating medium inside the bearing in normal conditions, therefore the static pressure bearing is not applicable for the general rotary mechanical parts that require compactness and high precision. On the other hand, a dynamic pressure bearing has tiny grooves inside the bearing hole, and the grooves has a lubricating medium inside the grooves (Since the groove is tiny, therefore the quantity of the lubricating medium is very little). When the axle center rotates, the lubricating medium inside the groove will be driven to produce a dynamic pressure to support the axle center in the central position.

Please refer to FIG. 1 for a dynamic pressure bearing being applied to the motor of a fan. The motor has a motor base 100, and the motor base 100 has an upwardly extended bearing cover 110 and the bearing cover 110 mounts a bearing 120. Please refer to FIG. 2. The bearing 120 has an axial hole 121 and the axial hole 121 has a plurality of dynamic pressure generating grooves 122 disposed on the wall of the periphery of the axial hole 121 and aligned in a fish bone like pattern. The dynamic pressure generating grooves 122 are inwardly tapered into a T shape, and a plurality of circular escape holes 123 is disposed around the periphery of the axial hole 121 among these dynamic pressure generating grooves, and a motor rotor 130 is disposed at the periphery of the bearing cover 110, and a motor rotor 140 is installed on the motor rotor 130. The motor rotor 140 comprises a fan vane 141 at the periphery of the motor rotor 140. Further, the motor rotor 140 comprises an axle center 143 passing through the axial hole 121 and a magnet 142 corresponding to the motor rotor 130. When the structure of this device is in use, the dynamic pressure generating groove 122 produces a drag to the lubricating medium in the axial hole 121 as to produce the dynamic pressure, and the axle center 143 is supported at the central position. However, when the axle center 143 is started, the pressure has not been established yet due to the dynamic pressure, and thus will cause an abrasion. Furthermore, it is very difficult to perform further manufacture inside the hole of the bearing 120, and it is also very difficult to control the precision. In general, the width of the groove is about 10 μm, and the depth is even smaller. Therefore, a fish bone like dynamic pressure generating groove is extended along the radial direction in the bearing 120, and that is a big challenge to the level of difficulty for manufacturers. Therefore, the current manufacturing method may not be able to complete the manufacture in the aforementioned shape. Even though this shape can be made, yet the precision cannot be enhanced easily which makes the manufacture very difficult and the mass production impossible.

### SUMMARY OF THE INVENTION

In view of the difficulty for the implementation and manufacture of the dynamic pressure bearing according to the prior art, the inventor of the present invention focused on the problems to start finding a way for the improvement and overcome the shortcomings in hope of find a feasible solution, and conducted extensive researches and experiments and finally invented the improved dynamic pressure bearing assembly in accordance with the present invention.

Therefore it is the primary objective of the present invention to provide an improved dynamic pressure bearing assembly that can be applied onto a rotary mechanic parts for supporting, reducing the friction and bearing the load, such as the one being applied onto a motor axle. Such device comprises a bearing, and the bearing comprises an axial hole passing through the bearing, and the axial hole at its periphery comprises a plurality of aslant planes extended along the axial direction, and a dynamic pressure generating groove is defined and embedded among these planes. Therefore, the periphery of the axial hole can be manufactured on the planes very easily and the dynamic pressure generating grooves are distributed equidistantly along the periphery of the axial hole, not only saving cost, but also enhance the yield rate of the product. The present invention can achieve the purposes of easy manufacturing and mass production, and also can evenly eject the fluid contained in everywhere inside each dynamic pressure generating groove towards the axle center by the drag of the centrifugal force, and further fix the axle center in place and maintain the axle center at the central position in the bearing.

Another objective of the present invention is to provide an improved dynamic pressure bearing assembly, wherein the planes of the bearing could be either a cut plane or a curved surface.

A further objective of the present invention is to provide an improved dynamic pressure bearing assembly, wherein the angle from the starting point to the ending point of its plane is variable, and the periphery of the axial hole is cut into various different geometric shapes.

Another further objective of the present invention is to provide an improved dynamic pressure bearing assembly, wherein a circular escape hole is disposed on a specific portion of its plane and extended along the axial direction of the axial hole, and the escape hole can divide the plane into two to several portions.

### BRIEF DESCRIPTION OF THE DRAWINGS

The above objects, features and advantages of the present invention will become apparent from the following detailed description taken with the accompanying drawings. However, these drawings are provided for reference and illustration and not intended to act as a limitation to the present invention.

FIG. 1 is a cross-sectional view of the dynamic pressure bearing assembly according to a prior art.

FIG. 2 is a cross-sectional view of a bearing of the dynamic pressure bearing assembly according to a prior art.

FIG. 3 is a perspective view of a bearing of the dynamic pressure bearing assembly according to the present invention.

FIG. 4A is a cross-sectional view of a bearing of the dynamic pressure bearing assembly according to a first preferred embodiment of the present invention.

FIG. 4B is a cross-sectional view of a bearing of the dynamic pressure bearing assembly according to a second preferred embodiment of the present invention.

FIG. 4C is a cross-sectional view of a bearing of the dynamic pressure bearing assembly according to a third preferred embodiment of the present invention.

FIG. 4D is a cross-sectional view of a bearing of the dynamic pressure bearing assembly according to a fourth preferred embodiment of the present invention.

FIG. 4E is a cross-sectional view of a bearing of the dynamic pressure bearing assembly according to a fifth preferred embodiment of the present invention.

FIG. 4F is a cross-sectional view of a bearing of the dynamic pressure bearing assembly according to a sixth preferred embodiment of the present invention.

FIG. 4G is a cross-sectional view of a bearing of the dynamic pressure bearing assembly according to a seventh preferred embodiment of the present invention.

FIG. 4H is a cross-sectional view of a bearing of the dynamic pressure bearing assembly according to an eighth preferred embodiment of the present invention.

FIG. 5A is a top view of a bearing of the dynamic pressure bearing assembly according to a preferred embodiment of the present invention.

FIG. 5B is a top view of a bearing of the dynamic pressure bearing assembly according to another preferred embodiment of the present invention.

FIG. 5C is a top view of a bearing of the dynamic pressure bearing assembly according to a further preferred embodiment of the present invention.

FIG. 5D is a top view of a bearing of the dynamic pressure bearing assembly according to another further preferred embodiment of the present invention.

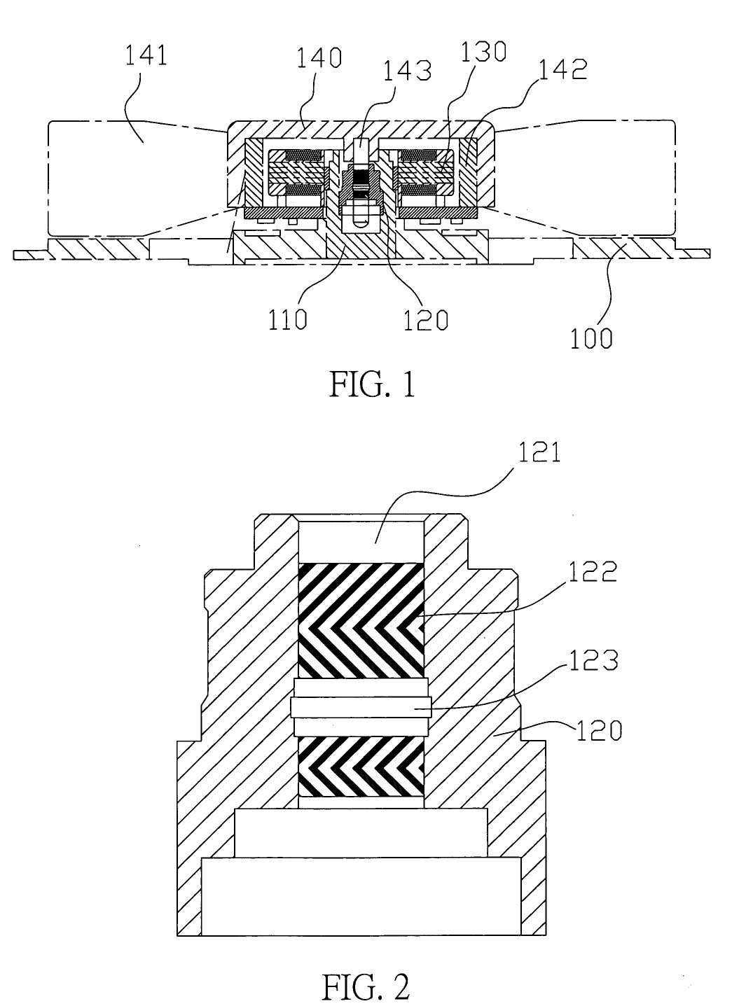

### DETAILED DESCRIPTION OF THE PREFERRED EMBODIMENTS

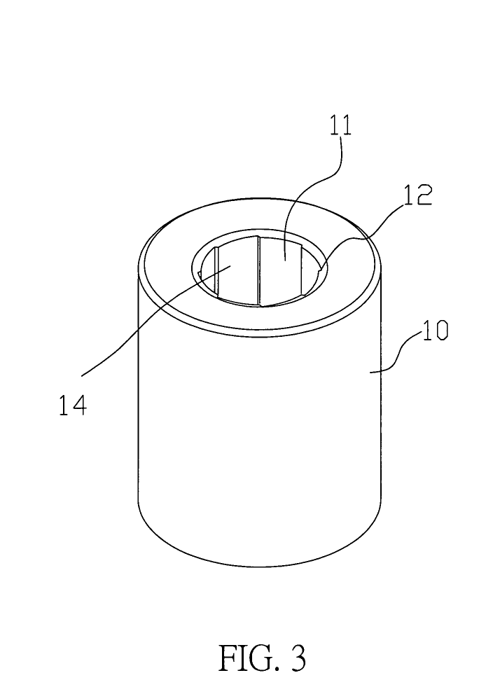

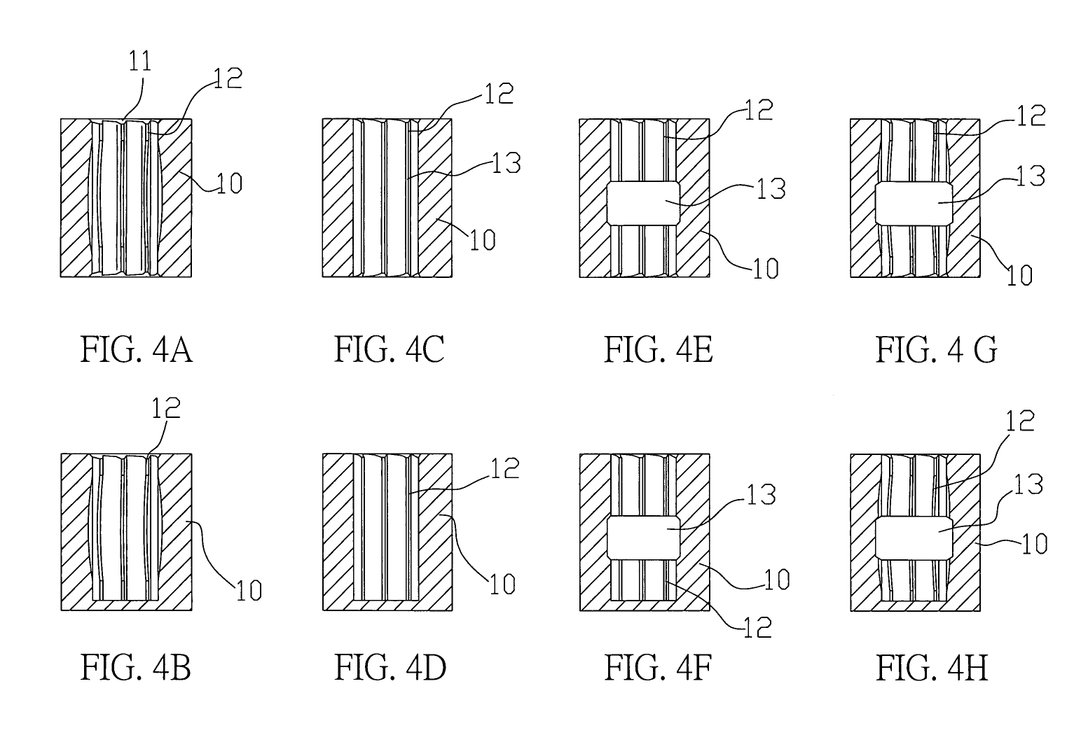

Please refer to FIGS. 3 and 4A to 4H for an improved dynamic pressure bearing assembly of the present invention. The dynamic pressure assembly is used on a rotary mechanical part for supporting, reducing the pressure and bearing the load, such as being used in a fan motor as shown in FIG. 1. The motor comprises a motor base 100, and a bearing cover 110 upwardly extended from the motor base 100, a motor stator 130 disposed at the periphery of the baring cover 110, a motor rotor 140 disposed on the motor stator 130, a vane 141 disposed on the periphery of the motor rotor 140. Further, the motor rotor 140 comprises an axle center 143 and a magnetic 142 corresponding to the motor stator 130.

Further, a bearing 10 passes into the axle cover 110; a penetrating axial hole 11 is disposed on the bearing 10; a plurality of aslant planes 14 is extended in the axial direction and disposed along the periphery of the axial hole 11, and the planes 13 are milled by a milling machine, and a recessed dynamic pressure generating groove 12 is disposed at an end of the plane with a larger slope. The dynamic pressure generating groove 12 comprises a fluid lubricating medium therein, so that the planes 14 can build the periphery of the axial hole in a manufacture, and the dynamic pressure generating grooves 12 are distributed equidistantly on the periphery of the axial hole by the partition of the plane and face the central position of the bearing 10 with a specific inclination. The present invention not only can save costs, but also enhances the yield rate of the product, and thus achieves the purposes of easy manufacturing and mass production, and also can evenly eject the fluid contained in everywhere inside each dynamic pressure generating groove 12 evenly towards the center of the bearing by the drag of the centrifugal force, and further fix the axle center (not shown in the figure) at the center of the bearing 10 and maintain the axle center at the central position in the bearing 10.

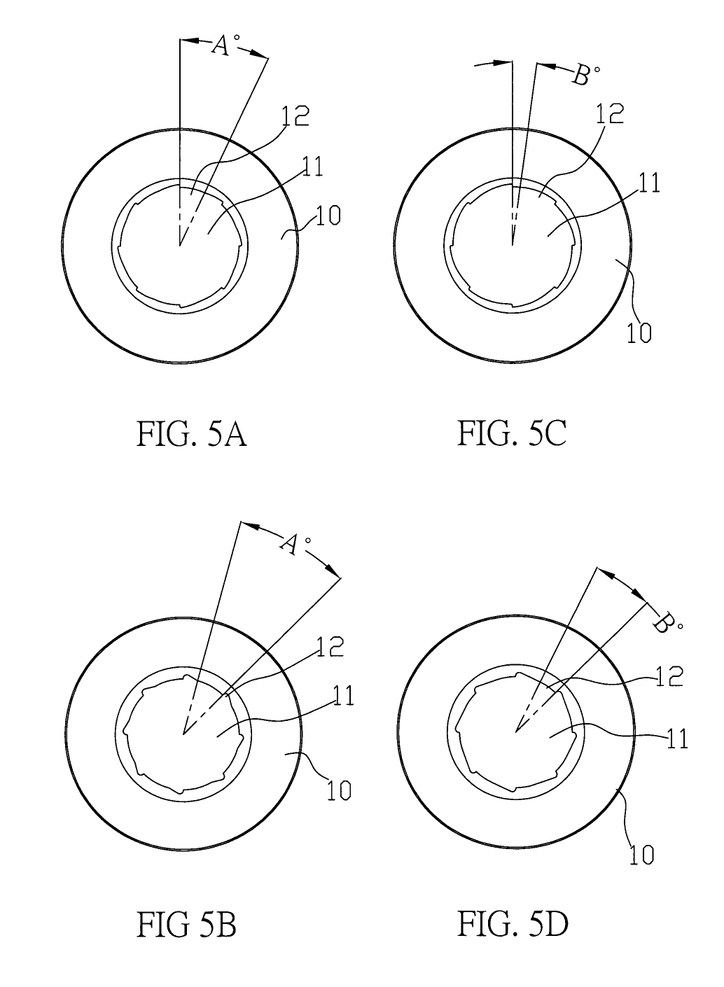

Please refer to FIGS. 4A to 4D. The surface of the plane 14 can be either in a cut plane or a curved surface. A circular escape hole 13 is extended in the radial direction along the axial hole and disposed on a specific portion of the plane 14 and the escape hole 13 can divide the plane 14 and the dynamic pressure generating grooves 12 into two to several portions as shown in FIGS. 4E to 4H). Furthermore, the angle (as indicated by A″ and B″ in FIGS. 5B, 5C and 5D) from the starting point to the ending point of its plane 14 is variable, and the periphery of the axial hole 11 is cut into various different geometric shapes such as a rectangular shape and a diamond shape, etc.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. An improved dynamic pressure bearing assembly, comprising:
a bearing,
an axial hole, penetrating said bearing;
a plurality of planes, being aslant and extended along a radial direction and disposed on the periphery of said axle hole; and
a dynamic pressure generating groove, being recessively disposed at one end of said plane having a larger slope and said dynamic pressure groove being separated by said planes and distributed evenly on the periphery of said axle hole, and facing the central position of said bearing with a predetermined angle;
thereby, said planes and said dynamic pressure generating grooves are installed easily along the periphery of said axial hole during its manufacturing and thus achieving the purpose of an easy manufacturing.

2. The improved dynamic pressure bearing assembly of claim 1, wherein said plane has a surface of a cut plane.

3. The improved dynamic pressure bearing assembly of claim 1, wherein said plane has a curved surface.

4. The improved dynamic pressure bearing assembly of claim 1, wherein said plane comprises an escape hole, being substantially in a circular shape and extended along a radial direction of said axial hole and said escape hole divides said plane and said dynamic pressure generating grooves on said plane into at least two portions.

5. The improved dynamic pressure bearing assembly of claim 1, wherein said plane has a variable angle between a starting point to an ending point on said plane, and the periphery of said axial hole is cut into various geometric shapes.
